(19) United States
(12) Patent Application Publication
(10) Pub. No.: US 2022/0253774 A1
(43) Pub. Date: Aug. 11, 2022

(54) IMPLEMENTING BIG DATA AND ARTIFICIAL INTELLIGENCE TO DETERMINE LIKELIHOOD OF POST-ACCEPTANCE FACILITY OR SERVICE RENUNCIATION

(71) Applicant: BANK OF AMERICA CORPORATION, Charlotte, NC (US)

(72) Inventor: Srinath S. Chakravarty, Plano, TX (US)

(73) Assignee: BANK OF AMERICA CORPORATION, Charlotte, NC (US)

(21) Appl. No.: 17/174,036

(22) Filed: Feb. 11, 2021

(51) Int. Cl. G06Q 10/06; G06N 20/00; G06F 16/2458; G06F 16/26

(52) U.S. Cl. CPC G06Q 10/06315; G06F 16/26; G06F 16/2465; G06N 20/00

(57) ABSTRACT

Big data searches, statistical computation and artificial intelligence are leveraged to determine the likelihood that a user will renounce a facility or service post-acceptance. Specifically, the present invention relies on facility/service data and/or user data to key a plurality of data mining searches of big data sources. In response to extracted responsive data from the big data sources, the present invention implements statistical computing along with machine learning/Artificial Intelligence techniques to determine a go/no-go indicator that indicates either (i) the user is unlikely to renounce (i.e., abandon, fail to use and/or return) the facility or service post-acceptance/acquisition, or (ii) the user is likely to renounce the facility/service.

### FIELD OF THE INVENTION

The present invention relates to big data searches, statistical computation and artificial intelligence and, more specifically, conducting big data searches and statistical computation to determine post-acceptance facility or service renunciation.

### BACKGROUND

In many instances, users may renounce a facility or service after they accepted or otherwise acquired the facility or service from an entity. Further, certain facilities or services require the entity to invest time and other resources in the process by which the user accepts or acquires the resource. Therefore, it would be advantageous to the entity to know ahead of time (i.e., prior to or at the onset of engaging the user to acquire/accept the facility or service) whether the user is likely to renounce the facility or service post-acceptance/acquisition. In this regard, the entity can make decisions to assume the peril and continue to pursue the user, forego pursuing the user or determine other facilities or services that the user is more likely to retain and/or utilize once than accepted or acquired the facility or service.

### SUMMARY OF THE INVENTION

The following presents a simplified summary of one or more embodiments in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by implementing big data searches, statistical computation and artificial intelligence to determine the likelihood that a user will renounce a facility or service post-acceptance. Specifically, the present invention relies on facility/service data and/or user data to key a plurality of data mining searches of big data sources. In response to extracted responsive data from the big data sources, the present invention implements statistical computing to determine a go/no-go indicator that indicates either that (i) the user is unlikely to renounce (i.e., abandon, fail to use and/or return) the facility or service post-acceptance/acquisition, or (ii) the user is likely to renounce (i.e., abandon, fail to use and/or return) the facility or service post-acceptance/acquisition. In additional embodiments of the invention, Artificial Intelligence (AI) is used to analyze previous likelihood of renunciation determinations to determine a confidence level which is used in the statistical computation of the go/no-go indicator.

The simplicity of the go/no-go indicator provides the entity with a clear indication of the user's intentions. As a result, once the entity receives the go/no-go indicator the entity can make informed decisions on whether to assume the peril of renunciation and continue to pursue the user, forego pursuing the user or determining other facilities or services more suited to the user (i.e., facilities or services that the user are less likely or unlikely to renounce post-acceptance/acquisition).

A system for determining a likelihood of of post-acceptance facility or service renunciation, defines first embodiments of the invention. The system includes a first computing platform including a first memory and one or more first processing devices in communication with the first memory. The first memory stores a first application that is executable by the one or more first processing devices and configured to receive inputs that define a facility or service data and user data associated with a user contemplating of the facility or service from an entity and communicate (i) the facility or service data, and (ii) the user data to a network-based computing platform.

The system further includes the network-based computing platform having a second memory and one or more second processing devices in communication with the second memory. The second memory stores a distributed computing data mining engine and a statistical computing engine that are executable by the one or more second processing devices. The distributed computing data mining engine is configured to receive the (i) facility or service data, and (ii) the user data communicated from the first application, and conduct a plurality of data mining searches of big data sources to extract data keyed to at least one of the (i) facility or service data and (ii) the user data. The statistical computing engine is configured to determine, based at least on, (i) the facility or service data, (ii) the user data, and (iii) the extracted data, a go/no-go indicator that indicates one of (a) the user is likely to renounce the facility or service post-acceptance of the facility or service, or (b) the user is unlikely to renounce the facility or service post-acceptance of the facility or service.

The first application is further configured to receive the go/no-go indicator and present, within a user interface, an indication that either (a) the user is likely to renounce the facility or service post-acceptance of the facility or service, or (b) the user is unlikely to renounce the facility or service post-acceptance of the facility or service.

In specific embodiments of the system, the distributed computing data mining engine is configured to conduct the plurality of data mining searches of big data sources to extract data keyed to at least one of the (i) facility or service data and (ii) the user data, such that each of the plurality of data mining searches is associated with one of a plurality of metrics for determining likelihood of the user renouncing the facility or service post-acceptance of the facility or service. In further related embodiments of the system, the statistical computing engine is configured to (i) determine, based at least on the extracted data, a quantifiable indicator for each of the plurality of metrics, (ii) weight each of the quantifiable indicators based on relevance to likelihood of the user renouncing the facility or service post-acceptance of the facility or service, (iii) determine, based on each of the weighted quantifiable indicators, an overall quantifiable indicator of the likelihood of the user renouncing the facility or service post-acceptance of the facility or service, and (iv) implement the overall quantifiable indicator in the statistical computation determine the go/no-go indicator.

In further specific embodiments of the system, the second memory of the network-based computing platform further stores an Artificial Intelligence (AI)-based machine-learning engine that is executable by the one or more second processing devices. The AI-based machine-learning engine is configured to learn, over time, from results of previous determinations of the likelihood renouncing the facility or service associated with the at least one of the facility or service and other users of the entity. In such embodiments of the system, the statistical computation engine uses the output of the machine-learning in the form of a confidence level to assist in the determination of the go/no-go indicator.

In other specific embodiments of the system the second memory of the network-based computing platform further stores charting and presentation engine that is executable by the one or more second processing devices. The charting and presentation engine is configured to construct at least one of one or more back-up data charts and/or graphs and presentations that provide back-up data used in determining the go/no-go indicator and communicate the at least one of one or more back-up charts and presentations to the first application of the first computing platform.

An apparatus for determining a likelihood of post-acceptance facility or service renunciation defines second embodiments of the invention. The apparatus includes a computing platform having a memory and one or more processing devices in communication with the memory. The memory stores a distributed computing data mining engine that is executable by the one or more processing devices and configured to receive (i) facility or service data, and (ii) the user data communicated from an application, and conduct a plurality of data mining searches of big data sources to extract data keyed to at least one of the (i) facility or service data and (ii) the user data. The memory further stores a statistical computing engine that is executable by the one or more processing devices and configured to determine, based at least on, (i) the facility or service data, (ii) the user data, and (iii) the extracted data, a go/no-go indicator that indicates one of (a) the user is likely to renounce the facility or service post-acceptance of the facility or service, or (b) the user is unlikely to renounce the facility or service post-acceptance of the facility or service, and communicate the go/no-go indicator to an application. The application is further configured to receive the go/no-go indicator and present, within a user interface, an indication that either (a) the user is likely to renounce the facility or service post-acceptance of the facility or service, or (b) the user is unlikely to renounce the facility or service post-acceptance of the facility or service.

In specific embodiments of the apparatus, the distributed computing data mining engine is configured to conduct the plurality of data mining searches of big data sources to extract data keyed to at least one of the (i) facility or service data and (ii) the user data, such that, each of the plurality of data mining searches is associated with one of a plurality of metrics for determining likelihood of the user renouncing the facility or service post-acceptance of the facility or service. In such embodiments of the apparatus, the statistical computing engine is configured to (i) determine, based at least on the extracted data, a quantifiable indicator for each of the plurality of metrics, (ii) weight each of the quantifiable indicators based on relevance to likelihood of the user renouncing the facility or service post-acceptance of the facility or service, (iii) determine, based on each of the weighted quantifiable indicators, an overall quantifiable indicator of the likelihood of the user renouncing the facility or service post-acceptance of the facility or service, and (iv) implement the overall quantifiable indicator in the statistical computation determine the go/no-go indicator.

In still further embodiments of the apparatus, the memory of the computing platform further stores an Artificial Intelligence (AI)-based machine-learning engine, executable by the one or more second processing devices and configured to learn, over time, from results of previous determinations of the likelihood renouncing the facility or service associated with the at least one of the facility or service and other users of the entity. In such embodiments of the system, the statistical computation engine uses the output of the machine-learning in the form of a confidence level to assist in the determination of the go/no-go indicator.

In further specific embodiments of the apparatus, the memory of the computing platform further stores a charting and presentation engine that is executable by the one or more second processing devices and configured to construct at least one of one or more back-up data charts and presentations that provide back-up data used in determining the go/no-go indicator that indicates one of (a) the user is likely to renounce the facility or service post-acceptance of the facility or service, or (b) the user is unlikely to renounce the facility or service post-acceptance of the facility or service, and communicate the at least one of one or more back-up charts and presentations to the application.

A computer-implemented method for determining a likelihood of post-acceptance facility or service renunciation defines third embodiments of the invention. The method is executed by one or more computing processor devices. The method includes receiving inputs that define a facility or service data and user data associated with a user contemplating acceptance of the facility or service from an entity. The method further includes conducting a plurality of data mining searches of big data sources to extract data keyed to at least one of the (i) facility or service data and (ii) the user data. In addition, the method includes determining, based at least on, (i) the facility or service data, (ii) the user data, and (iii) the extracted data, a go/no-go indicator that indicates one of (a) the user is likely to renounce the facility or service post-acceptance of the facility or service, or (b) the user is unlikely to renounce the facility or service post-acceptance of the facility or service. Moreover, the method includes presenting the go/no-go indicator within a user interface of a corresponding application.

In specific embodiments of the method conducting further comprises conducting the plurality of data mining searches of big data sources to extract data keyed to at least one of the (i) facility or service data and (ii) the user data, such that each of the plurality of data mining searches is associated with one of a plurality of metrics for determining likelihood of the user renouncing the facility or service post-acceptance of the facility or service. In related embodiments of the method, determining the go/no-go indicator further includes (i) determining, based at least on the extracted data, a quantifiable indicator for each of the plurality of metrics, (ii) weighting each of the quantifiable indicators based on relevance to likelihood of the user renouncing the facility or service post-acceptance of the facility or service, (iii) determining, based on each of the weighted quantifiable indicators, an overall quantifiable indicator of the likelihood of the user renouncing the facility or service post-acceptance of the facility or service, and (iv) implementing the overall quantifiable indicator in the statistical computation determine the go/no-go indicator.

In other specific embodiments the method includes machine-learning, over time, from results of previous determinations of the likelihood renouncing the facility or service associated with the at least one of the facility or service and other users of the entity. In such embodiments of the system, the statistical computation engine uses the output of the machine-learning in the form of a confidence level to assist in the determination of the go/no-go indicator.

In still further embodiments the method includes constructing at least one of one or more back-up data charts and presentations that provide back-up data used in determining the go/no-go indicator that indicates one of (a) the user is likely to renounce the facility or service post-acceptance of the facility or service, or (b) the user is unlikely to renounce the facility or service post-acceptance of the facility or service.

Thus, systems, apparatus, methods, and computer program products herein described in detail below provide for determining the likelihood of a user renouncing a facility or service post-acceptance/acquisition. Specifically, the embodiments herein described rely on data mining big data sources based on user and/or facility/service keys. The user data, the facility/service data and the data extracted from the data mining searches is subsequently to statistically determine a go/no-go indicator that indicates whether the either (i) the user is likely to renounce the facility/service post-acceptance or (ii) the user is unlikely to renounce the facility/service post-acceptance. The go/no-go indicator is subsequently presented to the entity from which the facilities/services are provided so that the entity can make informed decisions on to whether to assume the peril and continue to pursue the user, forego pursuing the user or identify other facilities/services that the user is more likely to retain and/or utilize post-acceptance.

### BRIEF DESCRIPTION OF THE DRAWINGS

Having thus described embodiments of the invention in general terms, reference will now be made the accompanying drawings, wherein:

FIG. 1 is a schematic/block diagram of a system for determining a likelihood of a user renouncing a facility or service post-acceptance, in accordance with embodiments of the present invention;

FIG. 2 is block diagram of a computing platform including first application configured for determining the likelihood of a user renouncing a facility or service post-acceptance, in accordance with embodiments of the present invention;

FIG. 3 is block diagram of a computing platform including data mining search engine and a statistical computing engine, in accordance with embodiments of the present invention;

FIG. 4 is a flow diagram of a comprehensive method for determining a likelihood of a user renouncing a facility or service post-acceptance, in accordance with embodiments of the present invention;

FIG. 5 is a schematic diagram highlighting a data mining process, in accordance with embodiments of the present invention;

FIG. 6 is a schematic diagram highlighting a process for determining a go/no-go indicator; in accordance with embodiments of the present invention; and

FIG. 7 is a flow diagram of a high-level method for determining a likelihood of a user renouncing a facility or service post-acceptance, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as PYTHON, JAVA, PERL, SMALLTALK, C++, SPARK SQL, HADOOP HIVE or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” or “configured for” perform (or “configured for” performing) a certain function in a variety of ways, including, for example, by having one or more general-purpose circuits perform the function by executing particular computer-executable program code embodied in computer-readable medium, and/or by having one or more application-specific circuits perform the function.

Thus, as described in more detail below, embodiments of the present invention provide for leveraging big data searches, statistical computation and artificial intelligence to determine the likelihood that a user will renounce a facility or service post-acceptance. Specifically, the present invention relies on facility/service data and/or user data to key a plurality of data mining searches of big data sources. In response to extracted responsive data from the big data sources, the present invention implements statistical computing to determine a go/no-go indicator that indicates either that (i) the user is unlikely to renounce (i.e., abandon, fail to use and/or return) the facility or service post-acceptance/acquisition, or (ii) the user is likely to renounce the facility or service post-acceptance/acquisition. In additional embodiments of the invention, Artificial Intelligence (AI) is used to analyze previous likelihood of renunciation determinations to determine a confidence level which is used in the statistical computation of the go/no-go indicator. The simplicity of the go/no-go indicator provides the entity with a clear indication of the user's intentions, so that an entity can make decisive and informed decisions regarding whether or not to continue to pursue the customer as a potential acquirer of the facility or service.

The present invention provides for an entity to assess the viability of customer with regards to the customer's likelihood to retain and/or utilize a facility or service offered by the entity. If the customer is determined to likely renounce (i.e., have “buyer's remorse) a facility or service after they have accepted or acquired the facility or service, the entity may choose to assume the peril and proceed with attempting to have the customer accept or acquire the facility/service, forego further continuing to pursue the customer or identify another facility or service to offer to the customer which the customer is more likely to retain and/or utilize (as determined by further iterations of the present invention). For example, in one specific use case, the entity is a financial institution offering an account, loan, credit card or the like to a potential new customer or an existing customer. The financial institution has a desire to know the customer's likelihood of renouncing the account, loan or credit card (i.e., not using/abandoning the facility/service or returning the account, loan, credit card after acquiring), so that the entity does not exhaust resources (time, processing resources and the like) in attempting to persuade the customer to accept/acquire the account, loan or credit card. As such, the present invention provides for assessing the user's likelihood of renunciation at the onset of the user/entity relationship or at the onset of the facility/service acquisition process, so as to limit the time other resources expended by the entity if the user is determined to be likely to renounce the facility/product.

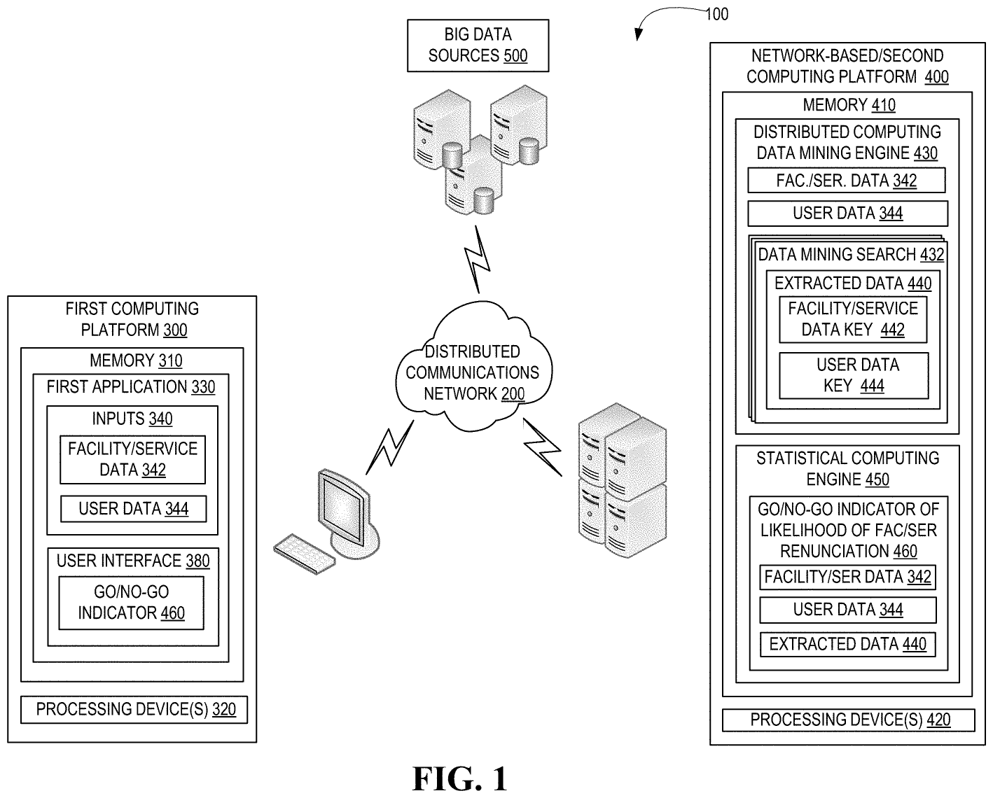

Turning now to the figures, FIG. 1 illustrates a system 100 for determining a likelihood of post-acceptance renunciation of a facility or service, in accordance with embodiments of the present invention. As previously discussed, the facility or service may be any product, service or the like offered by an entity, such as a financial institution, a realtor, a merchant, a vehicle dealership or the like. Post-acceptance renunciation also commonly referred to as “buyer's remorse” may result in the user rejecting or failing to use the facility or service and/or returning the facility/product to the entity. The present invention makes a determination of the likelihood of renunciation for the benefit of the entity offering the facility or service so that the entity can make decisions on whether to further pursue the user as a viable candidate for accepting/acquiring the facility or service. As such, the process of the present described embodiment of invention is typically undertaken at the onset of the prospective user engaging with the entity or otherwise considering accepting/acquiring the facility/service.

The system includes a first computing platform 300 and a network-based/second computing platform 400 that is in network communication with the first computing platform 300 via distributed communications network 200, which may include the Internet, one or more intranets, one or more cellular networks or the like.

First communication platform 300 includes a memory 310 and at least one processing device 320 in communication with the memory 310. In this regard, first computing platform 300 may comprise one or more computing devices, such as desktop computers, laptop computers, tablet computing devices or the like that are used by an associate or other individual associated or employed by the entity.

Memory 310 stores first application 330 that is configured to determine the likelihood of a user renouncing, post-acceptance/acquisition, a facility or service offered by the entity. First application 330 is configured to receive inputs 340 that define the facility/service, i.e., facility/service data 342 and user data 344. In specific embodiments of the invention, the inputs 340 may be provided to an electronic application form (i.e., another application or the like) required for accepting/acquiring the facility or service and subsequently communicated to the first application. For example, the financial institution scenario, the inputs 340 may be provided to a loan application, a credit card application or the like and subsequently communicated to first application 330. In other embodiments of the invention, the functionality/logic of first application 330 is incorporated into the electronic application forms, obviating the need to communicate the inputs from the electronic application to the first application 330. User data 344 may include any data related to the user that is germane to accepting or acquiring the facility or service (e.g., full name, address of residence, social security number, and the like). In response to receiving the inputs 340, first application 330, is configured to communicate the facility/service data 342, the user data 344 and, in some embodiments as discussed infra., other relevant data in possession of or accessible to the entity to a network-based computing platform 400.

Network-based/second computing platform 400 includes a memory 410 and at least one processing device 420 in communication with the memory 410. In this regard, computing platform 400 may comprise one or more computing devices, such as one or more application servers or the like.

Memory 410 stores distributed computing data mining engine 430, such as the Hadoop® software library, available from the Apache Software Foundation of Wakefield Mass., or the like, which allows for distributed processing and storage of large data sets across clusters of computers and a RESTful-based search engine, such as JavaScript Object Notation (JSON)-based Elasticsearch®, available from Elastic NV of Mountain View, Calif. or the like, which allows for searching big data sources. Data mining engine 430 is configured to receive the facility/service data 342, the user data 344 and, in some embodiments as discussed infra., other relevant data in possession of or accessible to the entity, and conduct a plurality of data mining searches 432 of big data sources 500 to extract relevant data 440. Each of the plurality of searches are related to one of a plurality of search categories and keyed to at least one of the facility/service (i.e., facility/service key 442) or the user (i.e., user key 444).

Memory 410 additionally stores statistical computing engine 450, which may comprise a combination of R programming language modules for statistical computing and presentation. Statistical computing engine 450 is configured to determine, based at least on the extracted data 440, the facility/service data 342 and the user data 344, a go/no-go indicator 460, a so-called “sticky bit value”, that indicates one of (i) the user is likely to renounce the facility/service post-acceptance/acquisition or (ii) the user is unlikely to renounce the facility/service post-acceptance/acquisition. Once the statistical computing engine 450 has determined the go/no-indicator 460, and, in some embodiments of the invention as discussed infra., other presentation information, charts, graphs or the like, the go/no-indicator 460 and, in some embodiments of the invention, any further presentation/chart/graph data is communicated to the first application 330 via distributed communication network 200.

First application 330 is further configured to receive the go/no-indicator 460 and, in some embodiments of the invention, any other presentation/chart/graph data and present the go/no-indicator 460 to the entity/associate via one or more user interfaces 380. By rendering a simplistic go/no-go indicator 460 and presenting the same to the entity/associate the present invention is able to provide the entity and/or associate with an easily comprehensible definitive indication of the user's likelihood of renouncing a facility/service post acceptance/acquisition. In the event that the user has been determined as likely to renounce the facility or product, the entity may choose to accept the peril and continue to pursue the user for acceptance/acquisition of the facility or service, forego pursuing the user for acceptance/acquisition of the facility or service and/or offer the user another similar facility or service that the user is less likely to renounce (i.e., a facility or service that undergoes the aforementioned process and results in a determination that the user is unlikely to renounce the facility/service post-acceptance/acquisition).

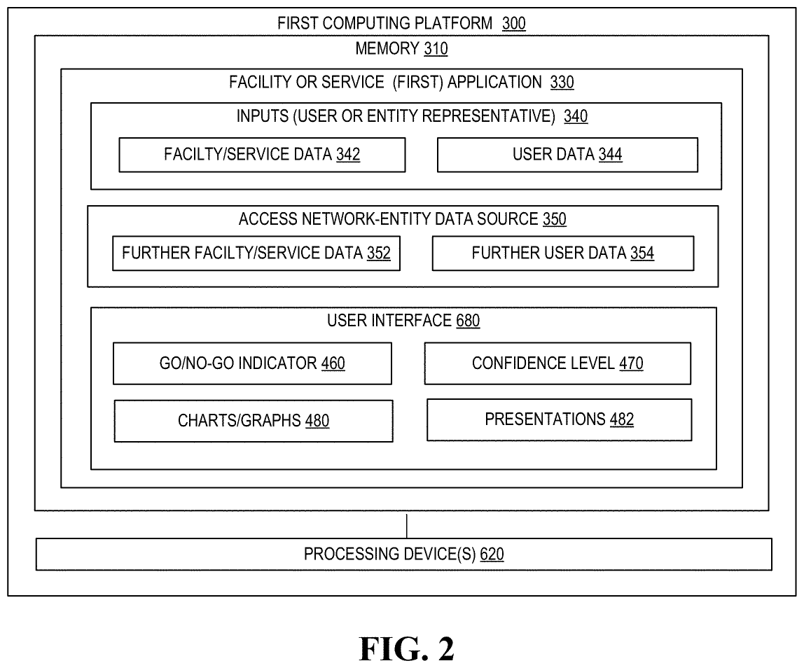

Referring to FIG. 2, a block diagram is depicted of a first computing platform 300 used in conjunction with the system 100 depicted and described in relation to FIG. 1. The computing platform 300 which may comprise one or more devices (e.g., PC, laptop, tablet, or the like), is configured to execute software programs, including engines, instructions, algorithms, modules, routines, applications, tools and the like. Computing platform 300 includes memory 310 and the like which may comprise volatile and non-volatile memory, such as read-only and/or random-access memory (RAM and ROM), EPROM, EEPROM, flash cards, or any memory common to computing platforms). Moreover, memory 310 and the like may comprise cloud storage, such as provided by a cloud storage service and/or a cloud connection service.

Further, first computing platform 300 also includes at least one processing device 320, which may be an application-specific integrated circuit (“ASIC”), or other chipset, logic circuit, or other data processing device configured to execute stored software/firmware including first application 330 or the like. Processing device(s) 320 or the like may execute one or more application programming interface (APIs) (not shown in FIG. 2) that interface with any resident programs, such as first application 330 or the like stored in the memory 310 of the computing platform 300 and any external programs. Processing device(s) 320 may include various processing subsystems (not shown in FIG. 2) embodied in hardware, firmware, software, and combinations thereof, that enable the functionality of first computing platform 300 and the operability of first computing platform 300 on distributed communications network 200 (shown in FIG. 1). For example, processing subsystems allow for initiating and maintaining communications and exchanging data with other networked devices, such as second computing platform 400 (shown in FIG. 1). For the disclosed aspects, processing subsystems of first computing platform 300 may include any processing subsystem used in conjunction with first application 330 and related engines, tools, routines, sub-routines, algorithms, sub-algorithms, sub-modules thereof

First computing platform 300 additionally includes a communications module (not shown in FIG. 2) embodied in hardware, firmware, software, and combinations thereof, that enables electronic communications between first computing platform 300 and other network devices, such as, but not limited to, second computing platform 400. Thus, communication module may include the requisite hardware, firmware, software and/or combinations thereof for establishing and maintaining a network communication connection with one or more network devices.

Memory 330 stores first application 330, which, as described in relation to FIG. 1, is configured to initiate and display results of a determination of the likelihood of a user renouncing a facility/service after accepting/acquiring the facility/service from an entity. In this regard, first application 330 is configured to receive inputs 340 that define the facility/service, i.e., facility/service data 342 and user data 344. In specific embodiments of the invention, the inputs 340 may be provided to an electronic application form (i.e., another application or the like) required for accepting/acquiring the facility or service and subsequently communicated to the first application. In other embodiments of the invention, the functionality/logic of first application 330 is incorporated into the electronic application forms, obviating the need to communicate the inputs from the electronic application to the first application 330.

In specific embodiments of the invention, in response to receiving the inputs 340, first application 330, is configured to compile further facility/service data 352 and/or further user data 354. For example, the entity may store of have access to results of previous acquisitions of the facility/service by other users, including previous instances in which the facility/service was renounced by other users (i.e., abandoned/unused or returned). In other examples, in which the user is a pre-existing user (i.e., a user with past or on-going relationship with the entity), the entity stores or has access to further user data, such as historical or current account data, transactional data, attribute data and the like.

In response to receiving the inputs 340 and, in some embodiments, the further facility/service data 352 and/or further user data 354, first application 330 is configured to communicate the facility/service data 342, the user data 344 and, in some embodiments, further facility/service data 352 and/or further user data 354 to the network-based computing platform 400.

In response to the network-based computing platform performing requisite big data searches and implementing statistical computing to determine the go/no-go indicator 460, the first application 330 is configured to present the go/no-go indicator 460 and, in some embodiments, chart(s)/graph(s) 492, 494 and presentation(s) 496 via one or more user interfaces 680.

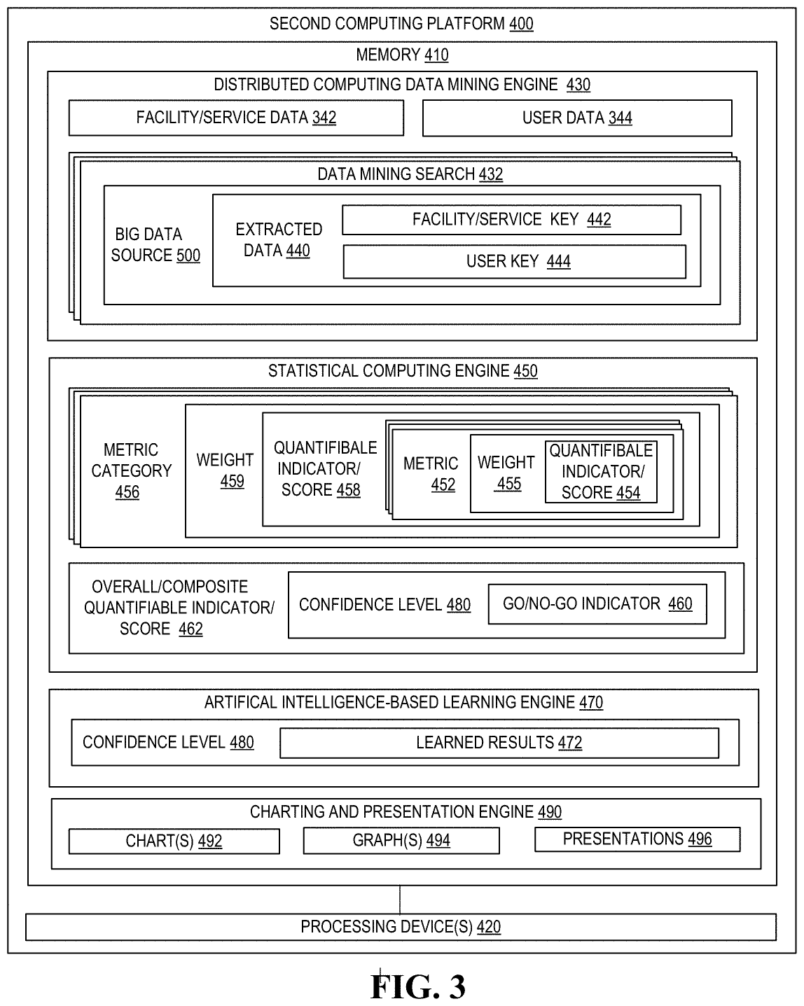

Referring to FIG. 3, a block diagram is depicted of a second computing platform 400 used in conjunction with the system 100 depicted and described in relation to FIG. 1. Second computing platform 400 which may comprise one or more devices (e.g., application servers, or the like), is configured to execute software programs, including engines, instructions, algorithms, modules, routines, applications, tools and the like. Second computing platform 400 includes memory 410 and the like which may comprise volatile and non-volatile memory, such as read-only and/or random-access memory (RAM and ROM), EPROM, EEPROM, flash cards, or any memory common to computing platforms). Moreover, memory 410 and the like may comprise cloud storage, such as provided by a cloud storage service and/or a cloud connection service.

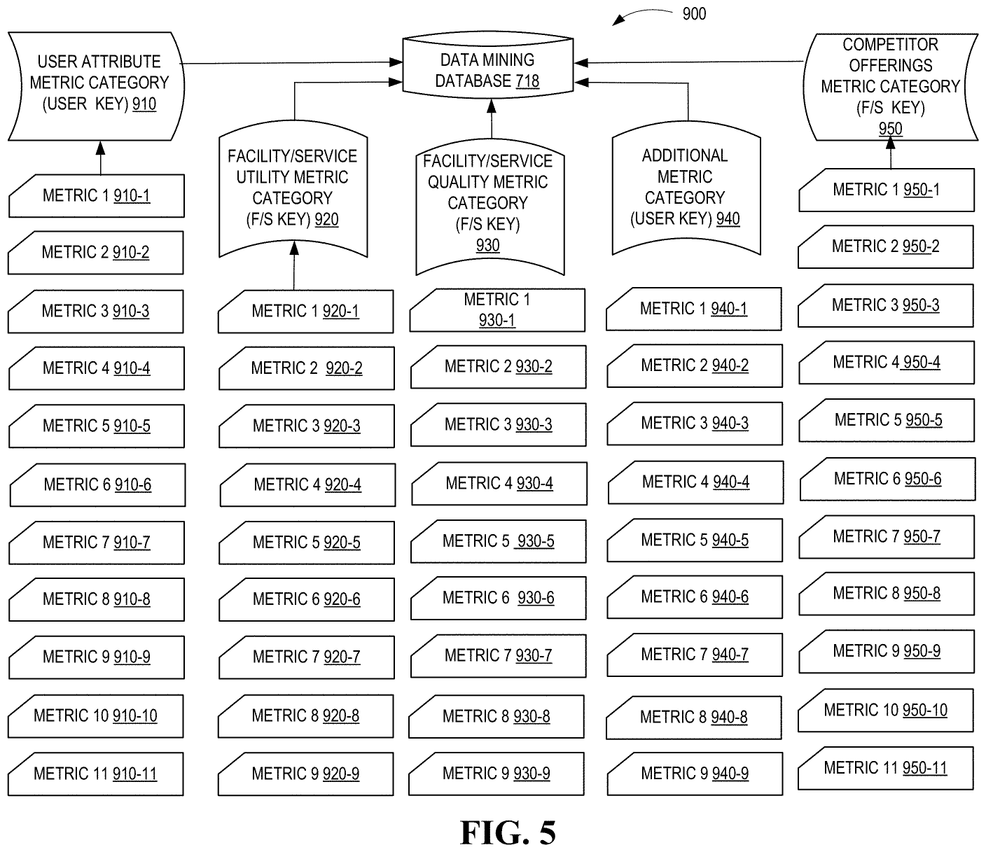

Further, second computing platform 400 also includes at least one processing device 420, which may be an application-specific integrated circuit (“ASIC”), or other chipset, logic circuit, or other data processing device configured to execute stored software/firmware including distributed computing data mining engine 430, statistical computing engine 450, AI-based machine-learning engine 470 and charting and presentation engine 490 or the like. Processing device(s) 420 or the like may execute one or more application programming interface (APIs) (not shown in FIG. 5) that interface with any resident programs, such as distributed computing data mining engine 430, statistical computing engine 450, AI-based machine-learning engine 470 and charting and presentation engine 490 or the like stored in the memory 410 of the second computing platform 400 and any external programs. Processing device(s) 420 may include various processing subsystems (not shown in FIG. 5) embodied in hardware, firmware, software, and combinations thereof, that enable the functionality of second computing platform 400 and the operability of second computing platform 400 on distributed communications network 200 (shown in FIGS. 1 and 2). For example, processing subsystems allow for initiating and maintaining communications and exchanging data with other networked devices, such as first computing platform 300 (shown in FIG. 1). For the disclosed aspects, processing subsystems of second computing platform 400 may include any processing subsystem used in conjunction with distributed computing data mining engine 430, statistical computing engine 450, AI-based machine-learning engine 470 and charting and presentation engine 490 and related engines, tools, routines, sub-routines, algorithms, sub-algorithms, sub-modules thereof.

Second computing platform 400 additionally includes a communications module (not shown in FIG. 5) embodied in hardware, firmware, software, and combinations thereof, that enables electronic communications between second computing platform 400 and other network devices, such as, but not limited to, first computing platform 300. Thus, communication module may include the requisite hardware, firmware, software and/or combinations thereof for establishing and maintaining a network communication connection with one or more network devices.

The memory 410 of second computing platform 400 stores distributed computing data mining engine 430 which is configured to receive the facility/service data 342 and the user data 344 from the first computing platform. The facility/service data 342 includes the data inputted or existing in the first application 330 (shown in FIG. 1), as well as, in specific embodiments, facility/service data stored by or accessible to the entity. The user data 344 includes the data inputted in the first application 330, as well as, in specific embodiments in which the user is a pre-existing user of the entity, user data stored by or accessible to the entity.

Data mining engine 430 is further configured to conduct a plurality of data mining searches 432 of big data sources 500 to extract relevant data 440. Each of the plurality of searches are related to one of a plurality of metric categories and keyed to at least one of the facility/service (i.e., facility/service key 442) or the user (i.e., user key 444). For example, in specific embodiments of the invention, the metric categories 456 may include, but are not limited to, user attribute metric category, facility/service utility metric category, facility/service quality metric category, competitor offering metric category and additional metric category. In such embodiments of the invention, in metric category 456 has a plurality of metrics 452 that are searchable within the big data sources 500. FIG. 5 described infra., highlights use of metric categories and associated metrics.

Memory 410 additionally stores statistical computing engine 450, which may comprise a combination of R programming language modules for statistical computing and presentation. Statistical computing engine 450 is configured to determine, based at least on the extracted data 440, the facility/service data 342 and the user data 344, a go/no-go indicator 460, a so-called “sticky bit value”, that indicates one of (i) the user is likely to renounce the facility/service post-acceptance/acquisition or (ii) the user is unlikely to renounce the facility/service post-acceptance/acquisition.

In specific embodiments of the invention the statistical computing engine 450 or, in some embodiments a scoring engine, is configured to determine quantifiable indicators/scores 454 for each metric 452 and assign a weight 455 to each quantifiable indicator/score 454 based on the predetermined significance of the metric 452 in determining a likelihood of renunciation. Further, the statistical computing engine 450 or scoring engine is configured to sum the weighted quantifiable indicators 454 of each of the metrics within a corresponding metric category 456 to result in a category quantifiable indicator/score 458 and assign a weight 459 to each category quantifiable indicator/score 458 based on the predetermined significance of the metric category 456 in determining a likelihood of renunciation. Subsequently each of the weighted category quantifiable indicators/scores are summed to result in an overall/comprehensive quantifiable indicator/score 462.

In further specific embodiments of the invention, the statistical computing engine 450 is configured to determine the go/no-go indicator 460 based on the overall/comprehensive quantifiable indicator/score 462 and, in some embodiments a confidence level 480. The confidence level 480 is determined by artificial intelligence(AI)-based machine learning engine 470 that is configured to machine learn from previous likelihood of renunciation determinations and apply the results 472 of the machine-learning to determine a confidence level 480 for the currently determined overall/comprehensive quantifiable indicator/score 462.

Additionally, memory 410 of second computing platform 400 stores charting and presentation engine 490 that is configured to construct charts 492, graphs 494 and/or presentations 496 that provide back-up/supplementary data that allows the entity insight into how and why the go/no-go indicator 460 was determined.

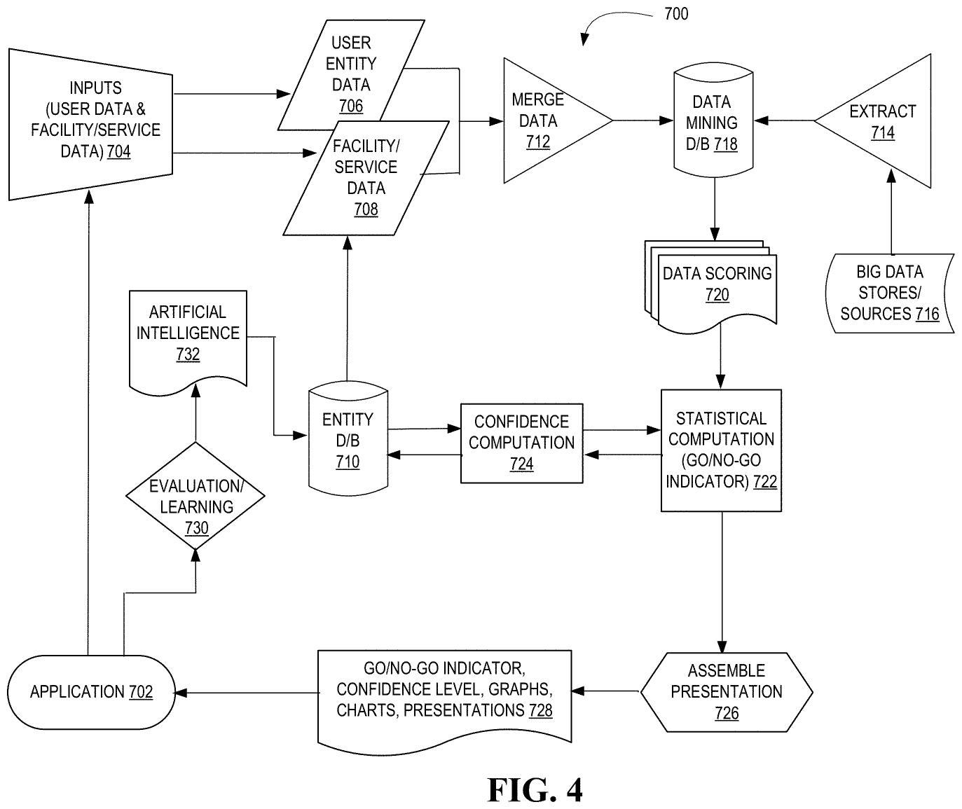

Referring to FIG. 4, a flow diagram is depicted of a methodology for determining a user's likelihood of renouncing a facility or service post-acceptance/acquisition, in accordance with embodiments of the present invention. At Start 702, an application is launched. The application may be a standalone application for determining a user's likelihood of renouncing a facility or service post-acceptance/acquisition or the application may be electronic form/application for accepting/acquiring a facility or product that includes embedded logic for determining a user's likelihood of renouncing a facility or service post-acceptance/acquisition. For example, in a financial institution use case, the application may be application form for accepting/acquiring an account, a loan, a credit card or the like.

At Event 704, an associate or the user provides inputs to the application which define user data and, in some embodiments, the facility or service. In other embodiments of the invention, the application may be specific to the facility or service, obviating the need to provide inputs that define the facility or service. At Event 706, when applicable, further user data is retrieved from one or more entity databases (710) or other databases accessible to the entity. Further user data will generally only exist in those instances in which the user has a previous or on-going relationship with the entity providing the facility or service. For example, in the financial institution use case, the user may be previous or current account or loan-holder of the financial institution. At Event 708, further facility/service data 708 is retrieved from one or more entity databases (710) or other databases accessible to the entity. At Event 712, the data from the inputs, as well as any further user data and/or facility/service data is merged and communicated to the data mining engine.

At Event 714, data mining searches are undertaken to extract data from big data stores/sources 716 and stores the extracted data in data mining database 718. The searches are keyed to one of the user or the facility/service. While processing speeds allow for data mining searches to be conducted in real-time to receiving the merged data (i.e., receiving the inputs at the application), it is possible to implement results from previously conducted data mining searches keyed to the facility or service which can be stored in the data mining database 718 for a predetermined period of time.

At Event 720, data scoring is executed on the extracted data. In specific embodiments of the invention, each metric that is searched is defined a score and the score is weighted based on the significance of the metric in determining likelihood of renunciation. In additional embodiments of the invention, each metric belongs to one of a plurality of metric categories, such that the sum of the weighted scores of each metric in the category defines the category score, which is then weighted based on the significance of the category in determining likelihood of renunciation. In such embodiments, the sum of the weighted scores of each category defines a comprehensive/overall score (i.e., quantifiable indicator) associated with the likelihood of renunciation.

At Event 722, statistical computation is performed to determine the go/no indicator, i.e., a so-called “sticky bit value” based on the comprehensive/overall score (i.e., quantifiable indicator) determined in the previous data scoring event (720) and a confidence level 724 determined/rendered from AI-based machine-learning from previous likelihood of renunciation determinations associated with the same or similar facility/service, the same user and/or other similarly situated users.

At Event 726, presentation(s), graph(s) and/or charts are constructed/assembled that provide back-up/support for the go/no-indicator (i.e., information that the entity can use to assess the logic used in determining the go/no-go indicator) and, at Event 728, the go/no-go indicator, along with any presentations, graphs and/or charts are communicated to the application where they are presented to the entity's associate on user interfaces. In response to receiving the go/no-go indicator, the entity can respond by choosing to assume the peril and continue to pursue the user, forego pursuing the user or identify other facilities or services that the user is more likely to retain and/or utilize post-acceptance/acquisition.

At Event 730, evaluation of the results of the results of the determination process are undertaken and, at Event 732, Artificial Intelligence to learn from the results of the determination process. The overall learned results are stored in entity database 710 and are used in rendering a confidence level 724 for subsequent likelihood of renunciation determinations, which is used in the statistical computation 722 of subsequent go/no-go indicator determinations.

Referring to FIG. 5 a schematic diagram is presented of data mining 900 conducted for purposes of subsequently determining a likelihood of facility/service renunciation, in accordance with embodiments of the present invention. In the example shown in FIG. 5, five metric categories are defined including (i) a user attribute metric category 910 keyed to the user; (ii) a facility/service utility metric category 920 keyed to the facility or service, (iii) a facility/service quality metric category 930 keyed to the facility or service, (iv) an additional metric category 940 keyed to the user, and (v) a competitor offerings metric category 950 keyed to the facility or service.

Each of the metric categories have a plurality of metrics, for example, user attribute metric category 910 includes metrics 1-11 910-1-910-11, which may include, but are not limited to, metrics which may not have been provided as inputs in the application 330. Facility/service utility metric category 920 includes metrics 1-9 920-1-920-9, which may include, but are not limited to, a volume of feature metric, a long term benefit metric, simplistic function/design metric, accessibility metric, value add metric, tangible results metric, cross functionality metric, portability metric, key needs metric and the like. Facility/service quality metric category 930 includes metrics 1-9 930-1-930-9, which may include, but are not limited to, a customer rating metric, a performance metric, functional attributes metric, reliability metric, availability metric, aesthetics metric, industry standards metric, novelty metric, uniqueness metric and the like. Additional metric category 920 includes metrics 1-9 940-1-940-9, which may include, but are not limited to, any other data that is relevant to gaining a better understanding of the user, including social media interaction and the like. Competitor offering metric category includes metrics 1-11 950-1-950-11, which may include, but are not limited to, similar product metric, encouragements/discount metric, brand appeal metric, market percentage metric, customer attention metric, user friendly metric, approval/acquisition process metric, metric and the like.

As previously discussed, once the searches are completed the results are stored in data mining database 718 for subsequent data scoring.

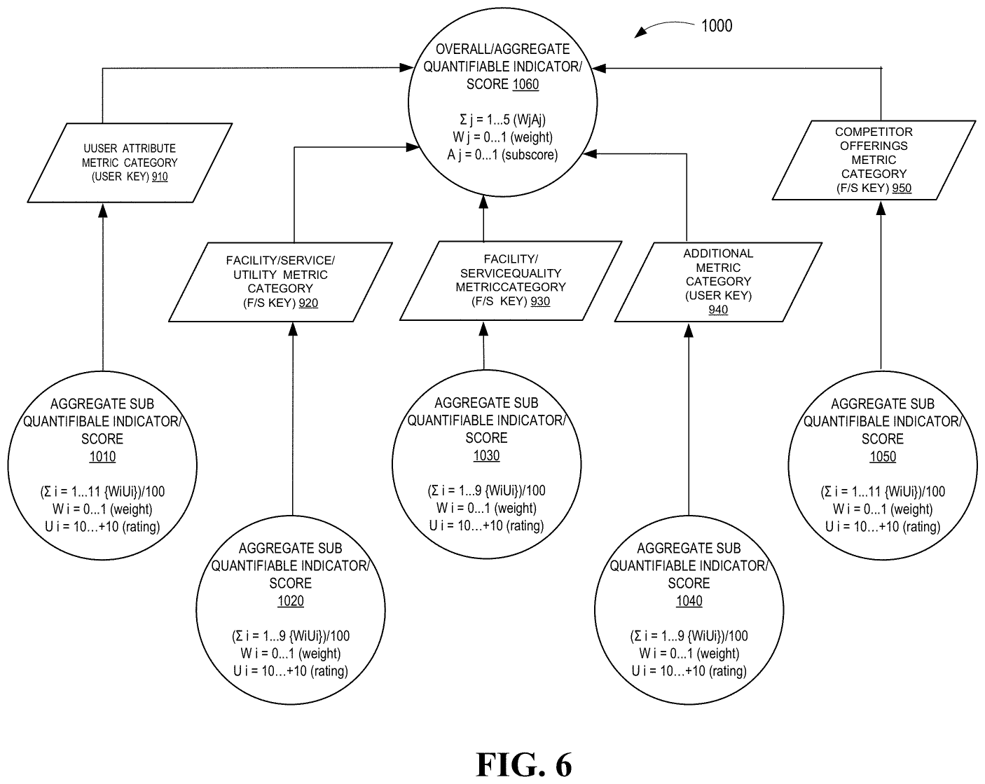

Referring to FIG. 6, a schematic diagram is presented of a methodology of data scoring, in accordance with embodiments of the present invention. Specifically, each of the metrics within one of the metric categories are provided a quantifiable indicator/score or rating that indicative of the data extracted from the big data sources as it pertains to likelihood of facility/service renunciation. A weighting value is then assigned to each of the quantifiable indicators/scores or ratings and the weighted scores/ratings are summed and divided by one hundred to result in a metric category score. The weighting value corresponds to the significance of the metric as it pertains to determination of likelihood of facility/service renunciation. For example, user attribute metric category 910 provides for aggregating the eleven metrics 910-1-910-11 (shown in FIG. 5) to result in a user attribute metric category-specific quantifiable indicator/score 1010. Facility/service utility metric category 920 provides for aggregating the nine metrics 920-1-920-9 (shown in FIG. 5) to result in a facility/service utility metric category-specific quantifiable indicator/score 1020. Facility/service quality metric category 930 provides for aggregating the nine metrics 930-1-930-9 (shown in FIG. 5) to result in a facility/service quality metric category-specific quantifiable indicator/score 1030. Additional metric category 940 provides for aggregating the nine metrics 940-1-940-9 (shown in FIG. 5) to result in an additional metric category-specific quantifiable indicator/score 1040. Competitor offerings metric category 950 provides for aggregating the eleven metrics 920-1-920-11 (shown in FIG. 5) to result in a competitor offering metric category-specific quantifiable indicator/score 1050.

Subsequently, once the aggregate metric category sub scores have been determined, an overall aggregate quantifiable indicator/score 1060 is determined by assigning a weighting value to each of the metric category sub scores. The weighting value corresponds to the significance of the metric category as it pertains to determination of likelihood of facility/service renunciation. The weighted sub scores are then summed to result in the overall aggregate quantifiable indicator score of the extracted metric data.

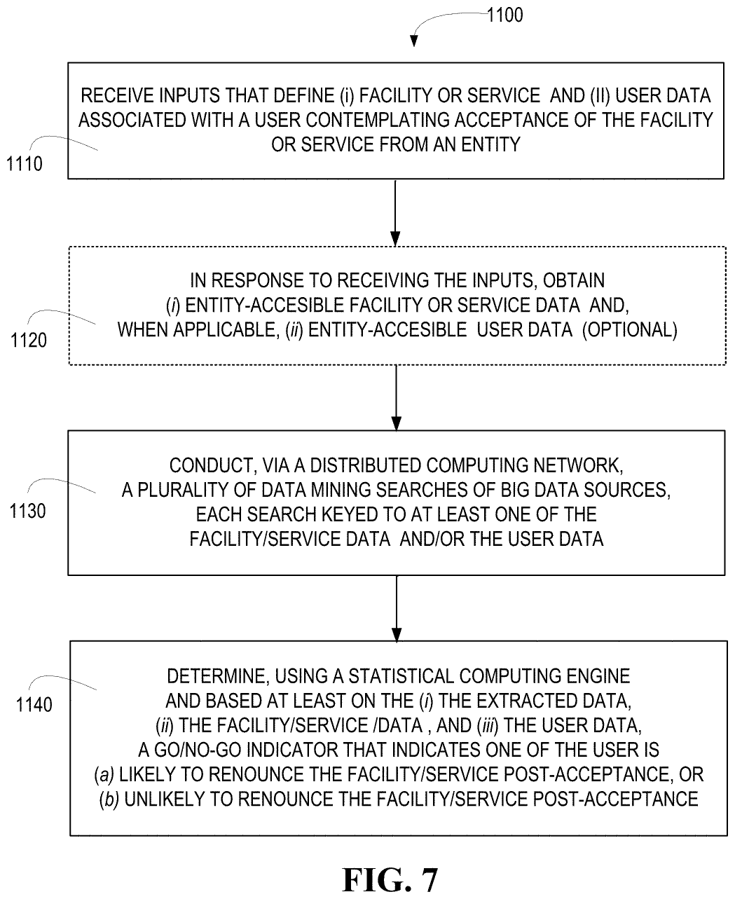

Referring to FIG. 7, a flow diagram is depicted of a method 1100 for determining the likelihood of facility or service renunciation post-acceptance/acquisition, in accordance with embodiments of the present invention. At Event 1110, inputs are received at an application or electronic form that define the facility or service and user data. The user data is associated with a user who desires or otherwise is considering to accept/acquire the facility or service from an entity. The inputs may be received from the user or from an associate of the entity. As previously discussed, in one specific financial institution-based use case, the inputs may be provided to a loan or credit card application.

In optional embodiments and in response to receiving the inputs, at Event 1120, further entity-accessible facility/service data and, when applicable, further entity-accessible user data is obtained and merged prior to downstream data mining and statistical computing. Further entity-accessible user data will be obtained only in instances in which the user is a previous or current user of the entity. Further facility/service data may include any data that is relevant to the determination of likelihood facility/service renunciation including, but not limited to, machine learned results of previous likelihood of renunciations determinations conducted on the same or similar service/facility and the like.

At Event 1130, a plurality of data mining searches are conducted across a distributed computing network to extract data from big data sources. As previously discussed, each search is specific to a metric and, in some embodiments a metric category and is keyed to at least one the facility/service or the user.

At Event 1140, a go/no-go indicator is determined that indicates one of (i) the user is likely to renounce the facility or service post-acceptance/acquisition, or (ii) the user is unlikely to renounce the facility or service post-acceptance/acquisition. The determination is based at least on the data mined/extracted from the big data sources, the facility/service data and the user data. In specific embodiments of the invention data scoring is executed on each of the metrics searched and/or each of the metric categories and weighting values are applied to each of the metric scores and/or metric category scores that are based on the relevant of the metric or metric category to the determination of the likelihood of facility/service renunciation. Each of the weighted metric scores or weighted metric category scores are summed to result in an overall metric score. Subsequently, statistical computation is implemented based at least on (i) the overall metric score and (ii) a confidence level rendered from AI-Based machine learning of previous likelihood of renunciation determinations to determine the go/no-go indicator.

Once the go/no-go indicator has been determined, the go/no-go indicator, along with any constructed supplemental data (i.e., presentations, charts, graphs and the like) is communicated back to the application for presentation to the entity. In this regard, according the present invention, the go/no-go indicator is presented only to the entity and not the user, such that the entity can make further decisions in the event of go/no-go indicator indicate that the user is likely to renounce the facility or service. For example, the entity may decide to assume the peril and continue pursuing the user for a facility/service acceptance, forego continuing to pursue the user, or identify one or more other facilities or services that the user is more likely to retain and/or utilize post-acceptance.

As evident from the preceding description, the systems, methods and the like described herein represents an improvement in resource utilization and, specifically, leveraging big data searches, statistical computation and artificial intelligence to determine the likelihood that a user will renounce a facility or service post-acceptance. Specifically, the present invention relies on facility/service data and/or user data to key a plurality of data mining searches of big data sources. In response to extracted responsive data from the big data sources, the present invention implements statistical computing to determine a go/no-go indicator that indicates either that (i) the user is unlikely to renounce (i.e., abandon, fail to use and/or return) the facility or service post-acceptance/acquisition, or (ii) the user is likely to renounce the facility or service post-acceptance/acquisition.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for determining a likelihood of post-acceptance facility or service renunciation, the system comprising:
a first computing platform including a first memory and one or more first processing devices in communication with the first memory, wherein the first memory stores a first application, executable by the one or more first processing devices and configured to:
receive inputs that define a facility or service data and user data associated with a user contemplating of the facility or service from an entity,
communicate (i) the facility or service data, and (ii) the user data to a network-based computing platform;
the network-based computing platform including a second memory and one or more second processing devices in communication with the second memory, wherein the second memory stores a distributed computing data mining engine and a statistical computing engine, executable by the one or more second processing devices, wherein the distributed computing data mining engine is configured to:
receive the (i) facility or service data, and (ii) the user data communicated from the first application, and
conduct a plurality of data mining searches of big data sources to extract data keyed to at least one of the (i) facility or service data and (ii) the user data, wherein the statistical computing engine is configured to:
determine, based at least on, (i) the facility or service data, (ii) the user data, and (iii) the extracted data, a go/no-go indicator that indicates one of the user is (a) likely to renounce the facility or service post-acceptance of the facility or service, or (b) unlikely to renounce the facility or service post-acceptance of the facility or service, and
communicate the go/no-go indicator to the first computing platform, wherein the first application is further configured to receive the go/no-go indicator and present, within a user interface, an indication that either the user is (a) likely to renounce the facility or service post-acceptance of the facility or service, or (b) unlikely to renounce the facility or service post-acceptance of the facility or service.

2. The system of claim 1, wherein the distributed computing data mining engine is configured to conduct the plurality of data mining searches of big data sources to extract data keyed to at least one of the (i) facility or service data and (ii) the user data, wherein each of the plurality of data mining searches is associated with one of a plurality of metrics for determining likelihood of the user renouncing the facility or service post-acceptance of the facility or service.

3. The system of claim 2, wherein the statistical computing engine is configured to:
determine, based at least on the extracted data, a quantifiable indicator for each of the plurality of metrics,
weight each of the quantifiable indicators based on relevance to likelihood of the user renouncing the facility or service post-acceptance of the facility or service,
determine, based on each of the weighted quantifiable indicators, an overall quantifiable indicator of the likelihood of the user renouncing the facility or service post-acceptance of the facility or service, and
implement the overall quantifiable indicator in the statistical computation determine the go/no-go indicator.

4. The system of claim 1, wherein the second memory of the network-based computing platform further stores an Artificial Intelligence (AI)-based machine-learning engine, executable by the one or more second processing devices and configured to:
machine learn, over time, from results of previous determinations of the likelihood renouncing the facility or service associated with the at least one of the facility or service and other users of the entity, and
communicate an output of the machine-learning to the statistical computing engine, wherein the output defines a confidence level.

5. The system of claim 4, wherein the statistical computing engine is further configured to determine, based further on (iv) the confidence level, the go/no-go indicator.

6. The system of claim 1, wherein the second memory of the network-based computing platform further stores charting and presentation engine, executable by the one or more second processing devices and configured to:
construct at least one of one or more back-up data charts and presentations that provide back-up data used in determining the go/no-go indicator that indicates one of the user is (a) likely to renounce the facility or service post-acceptance of the facility or service, or (b) unlikely to renounce the facility or service post-acceptance of the facility or service, and
communicate the at least one of one or more back-up charts and presentations to the first application.

7. The system of claim 6, wherein the first application is further configured to
receive the at least one of the one or more back-up charts and the presentations, and
present, within a user interface, the at least one of the one or more back-up charts and the presentations.

8. An apparatus for determining a likelihood of post-acceptance facility or service renunciation, the system comprising:
a computing platform including a memory and one or more processing devices in communication with the memory, wherein the memory stores:
a distributed computing data mining engine, executable by the one or more processing devices and configured to:
receive (i) facility or service data, and (ii) the user data communicated from an application, and
conduct a plurality of data mining searches of big data sources to extract data keyed to at least one of the (i) facility or service data and (ii) the user data,
a statistical computing engine, executable by the one or more processing devices and configured to:
determine, based at least on, (i) the facility or service data, (ii) the user data, and (iii) the extracted data, a go/no-go indicator that indicates one of the user is (a) likely to renounce the facility or service post-acceptance of the facility or service, or (b) unlikely to renounce the facility or service post-acceptance of the facility or service, and
communicate the go/no-go indicator to the application,
wherein the application is further configured to receive the go/no-go indicator and present, within a user interface, an indication that either the user is (a) likely to renounce the facility or service post-acceptance of the facility or service, or (b) unlikely to renounce the facility or service post-acceptance of the facility or service.

9. The apparatus of claim 8, wherein the distributed computing data mining engine is configured to conduct the plurality of data mining searches of big data sources to extract data keyed to at least one of the (i) facility or service data and (ii) the user data, wherein each of the plurality of data mining searches is associated with one of a plurality of metrics for determining likelihood of the user renouncing the facility or service post-acceptance of the facility or service.

10. The apparatus of claim 9, wherein the statistical computing engine is configured to:
determine, based at least on the extracted data, a quantifiable indicator for each of the plurality of metrics,
weight each of the quantifiable indicators based on relevance to likelihood of the user renouncing the facility or service post-acceptance of the facility or service,
determine, based on each of the weighted quantifiable indicators, an overall quantifiable indicator of the likelihood of the user renouncing the facility or service post-acceptance of the facility or service, and
implement the overall quantifiable indicator in the statistical computation determine the go/no-go indicator.

11. The apparatus of claim 8, wherein the memory of the computing platform further stores an Artificial Intelligence (AI)-based learning engine, executable by the one or more second processing devices and configured to:
machine learn, over time, from results of previous determinations of the likelihood renouncing the facility or service, wherein the results are associated with the at least one of the facility or service and other users of the entity,
communicate an output of the machine-learning to the statistical computing engine, wherein the output defines a confidence level.

12. the apparatus of claim 11, wherein the statistical computing engine is further configured to determine, based further on (iv) the confidence level, the go/no-go indicator.

13. The apparatus of claim 8, wherein the memory of the computing platform further stores a charting and presentation engine, executable by the one or more second processing devices and configured to:
construct at least one of one or more back-up data charts and presentations that provide back-up data used in determining the go/no-go indicator that indicates one of the user is (a) likely to renounce the facility or service post-acceptance of the facility or service, or (b) unlikely to renounce the facility or service post-acceptance of the facility or service, and
communicate the at least one of one or more back-up charts and presentations to the application.

14. A computer-implemented method for determining a likelihood of post-acceptance facility or service renunciation, the method is executed by one or more computing processor devices and comprising:
receiving inputs that define a facility or service data and user data associated with a user contemplating acceptance of the facility or service from an entity;
conducting a plurality of data mining searches of big data sources to extract data keyed to at least one of the (i) facility or service data and (ii) the user data,
determining, based at least on, (i) the facility or service data, (ii) the user data, and (iii) the extracted data, a go/no-go indicator that indicates one of the user is (a) likely to renounce the facility or service post-acceptance of the facility or service, or (b) unlikely to renounce the facility or service post-acceptance of the facility or service, and
presenting the go/no-go indicator within a user interface of a corresponding application.

15. The computer-implemented method of claim 14, wherein conducting further comprises conducting the plurality of data mining searches of big data sources to extract data keyed to at least one of the (i) facility or service data and (ii) the user data, wherein each of the plurality of data mining searches is associated with one of a plurality of metrics for determining likelihood of the user renouncing the facility or service post-acceptance of the facility or service.

16. The computer-implemented method of claim 15, wherein determining the go/no-go indicator further comprises:
determining, based at least on the extracted data, a quantifiable indicator for each of the plurality of metrics,
weighting each of the quantifiable indicators based on relevance to likelihood of the user renouncing the facility or service post-acceptance of the facility or service,
determining, based on each of the weighted quantifiable indicators, an overall quantifiable indicator of the likelihood of the user renouncing the facility or service post-acceptance of the facility or service, and
implementing the overall quantifiable indicator in the statistical computation determine the go/no-go indicator.

17. The computer-implemented method of claim 14, further comprising:
machine-learning, over time, from results of previous determinations of the likelihood renouncing the facility or service, wherein the results are associated with the at least one of the facility or service and other users of the entity.

18. The method of claim 17, wherein determining the go/no-go indicator further comprises determining, based further on (iv) a confidence level provided by an output of the machine-learning, the go/no-go indicator.

19. The computer-implemented method of claim 14, further comprising:
constructing at least one of one or more back-up data charts and presentations that provide back-up data used in determining the go/no-go indicator that indicates one of the user is (a) likely to renounce the facility or service post-acceptance of the facility or service, or (b) unlikely to renounce the facility or service post-acceptance of the facility or service.

20. The computer-implemented method of claim 19, further comprising;
presenting, within the user interface, the at least one of the one or more back-up charts and the presentations.
